(19) United States
(12) Patent Application Publication
(10) Pub. No.: US 2012/0084280 A1
(43) Pub. Date: Apr. 5, 2012

(54) SOCIAL NETWORK RESOURCE INTEGRATION

(76) Inventors: Horacio Ricardo Bouzas, Oslo (NO); Hallgrim Ludvigsen, Stavanger (NO)

(21) Appl. No.: 13/241,049

(22) Filed: Sep. 22, 2011

Related U.S. Application Data
(60) Provisional application No. 61/389,745, filed on Oct. 5, 2010.

(51) Int. Cl. G06F 17/30

(52) U.S. Cl. 707/723; 707/705; 707/E17.014

(57) ABSTRACT

A method can include creating an instance of a modeling application for a project and rendering an associated user interface to a display; accessing user identity data associated with the project; accessing social network data for one or more social network member profiles, optionally based on the user identity data; rendering accessed social network data to the display; receiving an instruction via the user interface; and accessing additional social network data responsive to receipt of the instruction. Various other apparatuses, systems, methods, etc., are also disclosed.

### CROSS-REFERENCE TO RELATED APPLICATION

This application claims the benefit of U.S. Provisional Patent Application 61/389,745 filed Oct. 5, 2010, entitled “Social Networking Applied to Collaboration Within Petro-Technical Applications,” the entirety of which is incorporated by reference herein.

### BACKGROUND

Various industries rely on computer-based modeling applications to perform tasks related to research, development, economics, etc. In such industries, a user may spend considerable time sitting in front of a display and interacting with a modeling application. As such applications tend to be knowledge and data driven, a user may experience productivity challenges when knowledge, data or both are not readily at accessible. According to an embodiment, various technologies and techniques provide for access to and sharing of knowledge and data.

### SUMMARY

A method can include accessing, via a modeling application, social network data and rendering accessed social network data to a display. Such a method may rank data, for example, as a ranking of member profiles based on information associated with a modeling project. A method may include rendering social network data to a display, receiving an instruction via a user interface, and accessing additional social network data responsive to receipt of the instruction. A method may include sharing of activities, knowledge or data. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating and optionally interacting with a geologic environment;

FIG. 2 illustrates an example of a system that includes a user layer, a private resource layer and a public resource layer;

FIG. 3 illustrates an example of a social network system, which may be a part of a public resource layer;

FIG. 4 illustrates an example of a system that includes one or more components for integrating social network resources into a framework;

FIG. 5 illustrates an example of a system that includes an indexer to access various data sources and index data;

FIG. 6 illustrates an example of a method for accessing social network data;

FIG. 7 illustrates an example of a method to retrieve social network data and to store such data in association with user identity data for users of a modeling application;

FIG. 8 illustrates an example of a graphical user interface for interacting with project data and an example of a method for ranking data such as social network data;

FIG. 9 illustrates an example of a scenario for ranking social network member profiles; and

FIG. 10 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

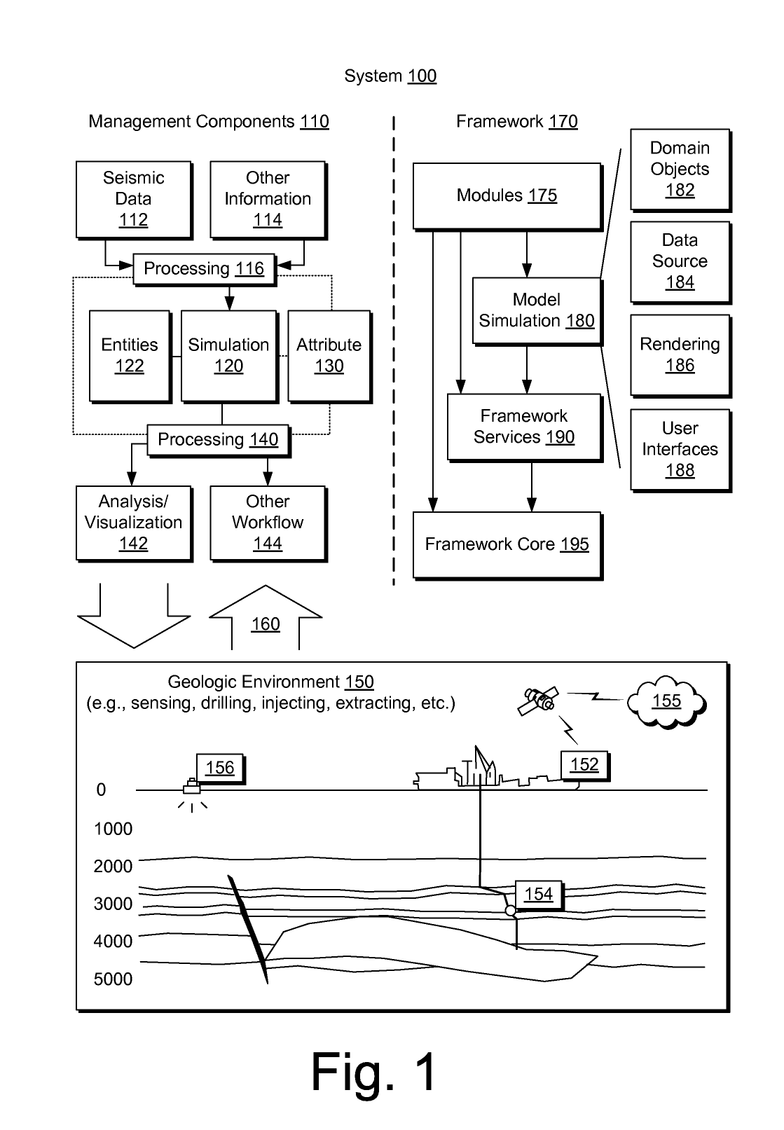

FIG. 1 shows an example of a system 100 that includes various management components 110 to manage various aspects of a geologic environment 150. For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc.

As to the management components 110 of FIG. 1, these may include a seismic data component 112, an information component 114, a pre-simulation processing component 116, a simulation component 120, an attribute component 130, a post-simulation processing component 140, an analysis/visualization component 142 and a workflow component 144. In operation, seismic data and other information provided per the components 112 and 114 may be input to the simulation component 120, optionally with pre-simulation processing via the processing component 116.

According to an embodiment, the simulation component 120 may rely on entities 122. Entities 122 may be earth entities and/or geological objects such as wells, surfaces, reservoirs, etc. In the system 100, the entities 122 may include virtual representations of actual physical entities that are reconstructed for purposes of simulation. The entities 122 may be based on data acquired via sensing, observation, etc. (e.g., the seismic data 112 and other information 114).

According to an embodiment, the simulation component 120 may rely on a software framework such as an object-based framework. In such a framework, entities may be based on pre-defined classes to facilitate modeling and simulation. A commercially available example of an object-based framework is the MICROSOFT®.NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may be a library of attributes. Such processing may occur prior to input to the simulation component 120. Alternatively, or in addition to, the simulation component 120 may perform operations on input information based on one or more attributes specified by the attribute component 130. According to an embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results. Additionally, or alternatively, output from the simulation component 120 may be input to one or more other workflows, as indicated by a workflow component 144.

According to an embodiment, the management components 110 may include features of a commercially available simulation framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment).

According to an embodiment, the management components 110 may include features for geology and geological modeling to generate high-resolution geological models of reservoir structure and stratigraphy (e.g., classification and estimation, facies modeling, well correlation, surface imaging, structural and fault analysis, well path design, data analysis, fracture modeling, workflow editing, uncertainty and optimization modeling, petrophysical modeling, etc.). Particular features may allow for performance of rapid 2D and 3D seismic interpretation, optionally for integration with geological and engineering tools (e.g., classification and estimation, well path design, seismic interpretation, seismic attribute analysis, seismic sampling, seismic volume rendering, geobody extraction, domain conversion, etc.). As to reservoir engineering, for a generated model, one or more features may allow for simulation workflow to perform streamline simulation, reduce uncertainty and assist in future well planning (e.g., uncertainty analysis and optimization workflow, well path design, advanced gridding and upscaling, history match analysis, etc.). The management components 110 may include features for drilling workflows including well path design, drilling visualization, and real-time model updates (e.g., via real-time data links).

According to an embodiment, various aspects of the management components 110 may be add-ons or plug-ins that operate according to specifications of a framework environment. For example, a commercially available framework environment marketed as the OCEAN® framework environment (Schlumberger Limited) allows for seamless integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. According to an embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may be the commercially available OCEAN® framework where the model simulation layer 180 is the commercially available PETREL® model-centric software package that hosts OCEAN® framework applications. According to an embodiment, the PETREL® software may be considered a data-driven application.

The model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for all application user interface components.

In the example of FIG. 1, the domain objects 182 can include entity objects, property objects and optionally other objects. Entity objects may be used to geometrically represent wells, surfaces, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects (see, e.g., domain objects 182).

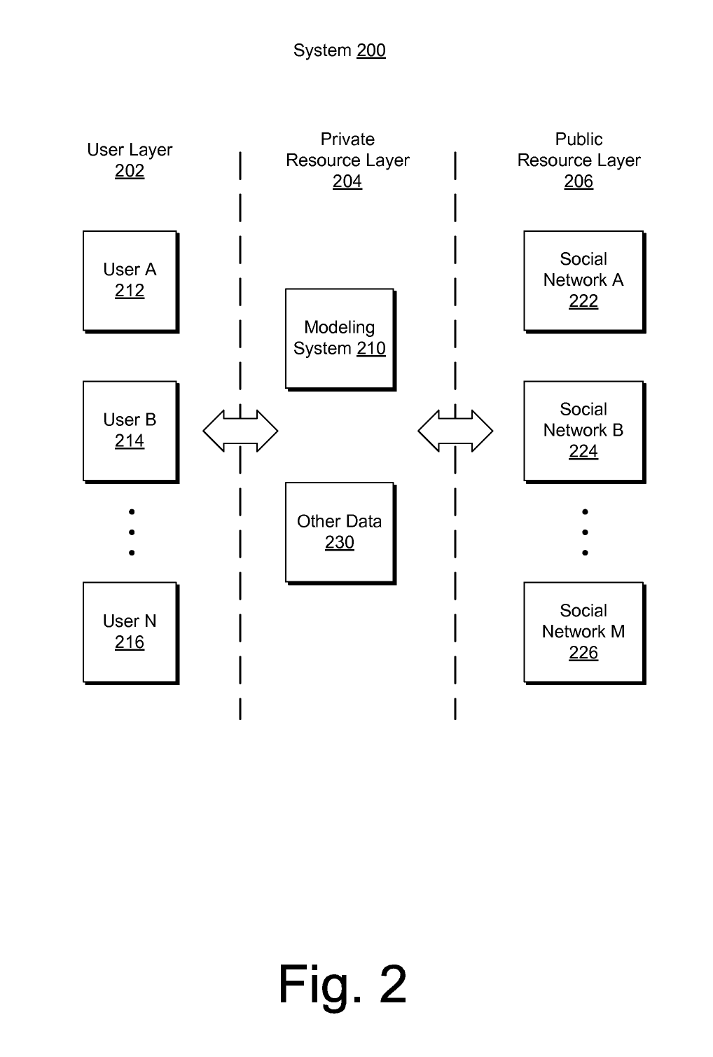

According to an embodiment, a system may include a framework configured with one or more modules (e.g., code, plug-ins, APIs, etc.) to leverage public resources and optionally share information via public resources. FIG. 2 shows an example of a system that includes a user layer 202, a private resource layer 204 and a public resource layer 206. In the example of FIG. 2, the user layer 202 may include various users 212, 214 and 216 that have permissions or credentials for using the modeling system 210 of the private resource layer 204, and optionally accessing other date 230, which may be considered private or proprietary. For example, the other data 230 may include human resources data, data from a licensed data source, or data compiled and organized by a private entity. As to the modeling system 210, it may be a model simulation layer such as the layer 180 of the framework 170 and may include one or more of the management components 110 of FIG. 1. According to an embodiment, a framework such as the framework 170 may be part of the private resource layer 204 and include private, public or private and public modules configured to interact with the public resource layer 204 and optionally the other data 230 of the private resource layer 204. As to the public resource layer 206, in the example of FIG. 2, it includes one or more social networks 222, 224 and 226 and optionally other sources of public information (e.g., open to public, which may include subscription sources whether free, fee-based, ad-based, etc.).

According to an embodiment, users of a modeling system can benefit from resources that exist in a public resource layer where such resources may be social network resources. As an example, consider a user that spends considerable time sitting in front of a display and interacting with a modeling application. As such an application tends to be knowledge and data driven, the user may experience productivity challenges when knowledge, data or both are not readily at accessible. To help overcome such challenges, one or more components may integrate social network data into a modeling experience. Accordingly, when a user desires knowledge or data, the user may invoke a component (e.g., during a modeling session) where the component responds by rendering relevant social network data to the display. The social network data may include relevant information as to features of the modeling application, features of a geologic reservoir, features of equipment used to explore a reservoir, features of equipment to extract or inject material, individuals or groups with expertise, etc. According to an embodiment, such information may be available for free, a fee, share-alike, membership, subscription or other basis.

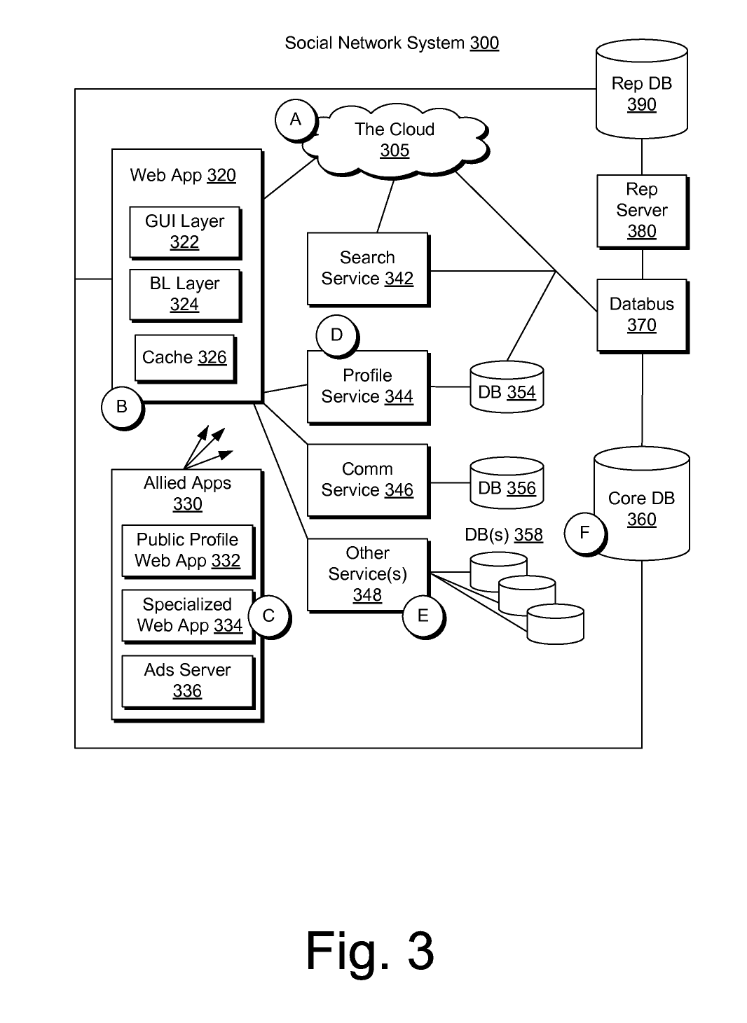

FIG. 3 shows an example of a social network system 300, which may be akin to the LINKEDIN® social network system (LinkedIn Corporation, Mountain View, Calif.). The system 300 includes access to “the cloud” 305, which is a distributed system that includes storage, communication and computing devices. Some have called “the cloud” a metaphor for “the Internet”. According to an embodiment, “the cloud” and “the Internet” include storage, communication and computing devices; noting that “the cloud” also includes resources to perform so-called “cloud computing”, which may be extensive, directed to particular computing tasks and not necessarily essential to “the Internet”, which may be considered “a network of networks”.

As shown in FIG. 3, components of the social network system 300 include a web application 320 and one or more allied applications 330. Such applications may be client-side application that can communicate, directly or indirectly, with one or more other components such as one or more service components. In the example of FIG. 3, service components include a search service component 342, a profile service component 344, a communication service component 346 and one or more other service components 348. In general, such service components can mediate communication between clients and data, which may be stored in various databases of a data architecture of the system 300. Such a data architecture can include service databases 354, 356 and 358, a core database 360 and a replication database 390. As to data transactions with the core database 360, the replication database 390, and the cloud 305, a databus component 370 may mediate traffic. In the system 300, various actions may be performed using clients, servers, routers, adapters, load balancers, etc. Thus, while a single server is shown (e.g., a replication server 380), it is understood that the system 300 includes additional servers to perform various actions.

As to the web application 320, it can include a so-called N-tier architecture with a presentation tier, a business tier and a data tier, shown as, for example, a graphical user interface (GUI) layer 322, a business logic (BL) layer 324 and a cache 326. As to the allied applications 330, these may include a public profile web application 332, one or more specialized web applications 334 and one or more advertisement web applications associated with one or more ad servers 336. According to an embodiment, advertisements may be for consultants, services, data, software, computing or other equipment, etc.

As to integration of such social network resources into a modeling application, the letters A, B, C, D, E and F identify some integration points. As to point A, integration may occur by accessing a social network via the cloud 305, for example, where the modeling application or associated framework includes a “browser” component that can access a website or other component of the social network system 300.

As to point B, such a web application may be included in a modeling application or associated framework where features allow for interaction between modeling application data and input and the web application (e.g., access via a GUI layer, a business logic layer, a cache, etc.).

As to point C, a modeling application or associated framework may include an integrated specialized web application or allow for a plug-in specialized web application that allows a user to leverage the social network resources from an instance of the modeling application.

As to point D, a modeling application or associated framework may include a component that interacts with a profile service of a social network. As an example, such a component may be part of a framework services layer of a framework associated with a modeling application.

As to point E, a modeling application or associated framework may include a component that interacts with a specialized service. For example, a company that uses a modeling application may acquire a license for access to one or more databases of a social network system. In such an arrangement, operators of the social network system may provide the company with a specialized service, optionally with security and optionally limited to certain profile data (e.g., for members, which may be individuals or other entities).

As to point F, where a social network system allows access to a core database, for example, via one or more application programming interfaces, communication ports, etc., a modeling application or associated framework may include a component that conforms queries, requests, etc., to the standards relied on by the social network system to thereby access data in the core database (e.g., SQL or other access mechanisms for relational or other types of databases).

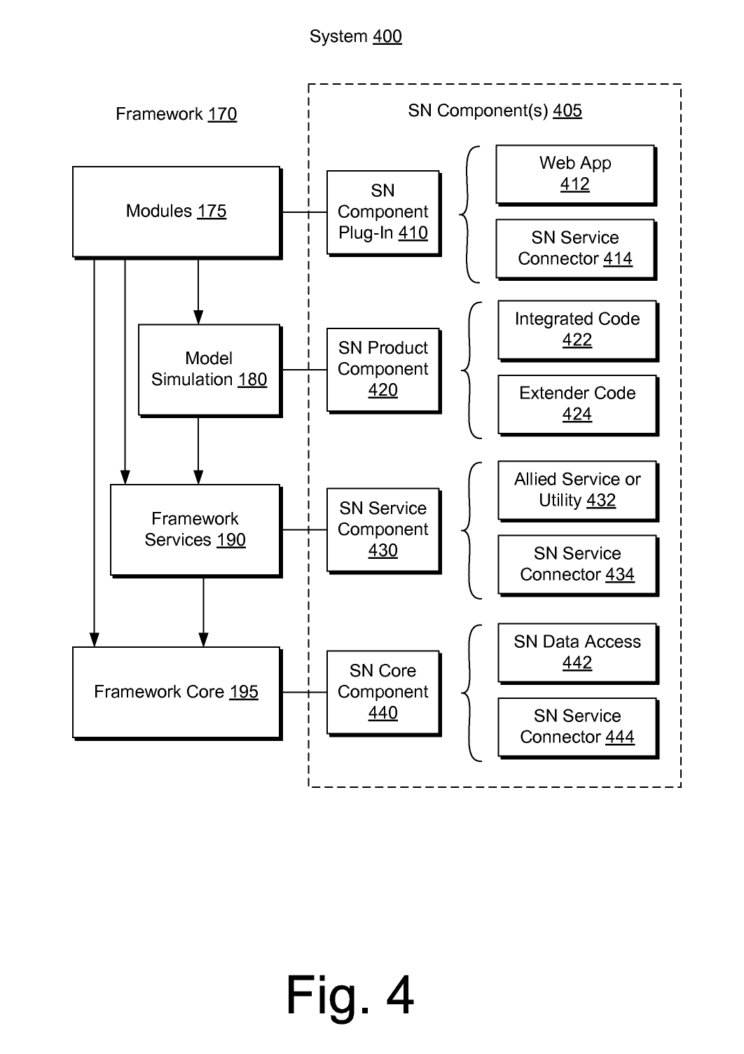

FIG. 4 shows an example of a system 400 that shows the framework 170 in association with various examples of components 405 for accessing social network resources. In the example of FIG. 4, a social network (SN) component plug-in 410 may be an application module, deployed as a plug-in or extension module. Such a component may be, for example, a web application component 412 or a service connector 414 to connect to a service, such as a service of a social network. According to an embodiment, a web application may access a private website that accesses private data, which may be, for example, a combination of private and public data (e.g., private data of a company and public data of a social network or social networks).

At the level of the model simulation layer 180, a social network component 420 may be, for example, integrated as code 422 or extender code 424. As to the latter, extender code may optionally leverage features in an existing portion of simulation code that can access a website or perform other actions associated with social network types of data.

At the framework services level 190, a social network service component 430 may be, for example, an allied service or utility component 432 or a connector component 434. At the framework core level 195, a social network core component 440 may be, for example, a data access component 442 or a service connector component 444.

According to an embodiment, a component to access one or more social network resources may operate according to representational state transfer (REST). In a REST architecture, a client initiates a request to a server and a server processes the request and returns an appropriate response. Such requests and responses are built around transfer of representations of resources where a resource can be essentially any coherent and meaningful concept that may be addressed (e.g., having an IP address). RESTful architectures can be based on HTTP or other Application Layer protocols, for example, where they provide a rich and uniform vocabulary for applications based on the transfer of meaningful representational state. RESTful applications aim to maximize the use of the pre-existing, well-defined interface and other built-in capabilities provided by the chosen network protocol, and minimize the addition of new application-specific features on top of it.

According to an embodiment, components may be organized in a model-view-controller (MVC) architecture that isolates “domain logic” (application logic for a user) from a user interface (e.g., input and presentation), which can permit independent development, testing and maintenance of each component (e.g., separation of concerns). In the MVC architecture, a model represents the state of a particular aspect of an application (e.g., where the model maps to a database table with the entries in the table representing the state of the application); a controller handles interactions and updates the model to reflect a change in state of the application, and then passes information to the view; and a view accepts necessary information from the controller and renders a user interface to a display. Some examples of frameworks that allow for MVC architecture include the .NET® framework and the Ruby On Rails® framework (Hansson, D. H., Chicago, Ill.).

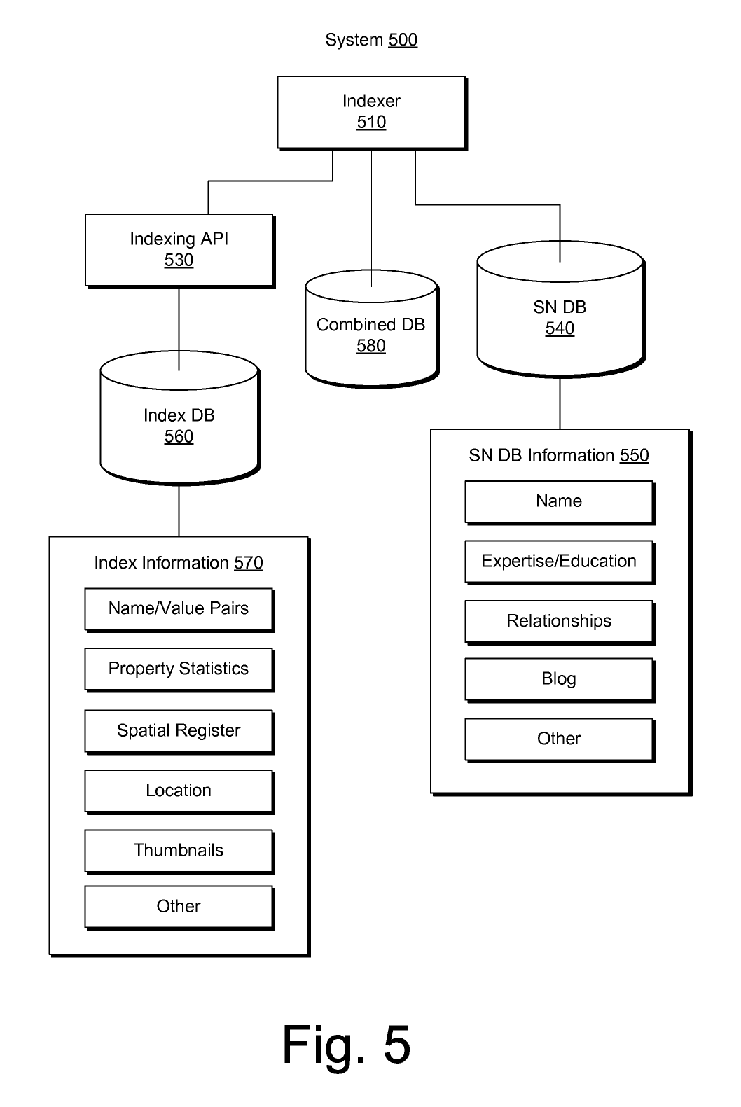

FIG. 5 shows an example of a system 500 that includes an indexer 510 to index data. In the example of FIG. 5, a social network database 540 includes database information 550, which may include, for a particular member, member name, member expertise, member education, member relationships to other members, member blog, or other member information. Further, an index database 560 include information 570, which may include, for a particular application project, name/value pairs, property statistics, spatial register, location, thumbnails, or other project related information.

According to an embodiment, an application programming interface (API) 530 may allow the indexer 510 to access and optionally retrieve information 570 in the index database 560. In turn, the indexer 510 can access and optionally retrieve information 550 in the social network database 550. Logic within the indexer 510 can provide for associating the social network information 570 with index information 570. The indexer 510 may generate an index and store the index, for example, in a manner akin to a search engine that indexes websites (e.g., where the indexer 510 collects, parses, and stores data to facilitate fast and accurate information retrieval). As shown in the example of FIG. 5, the indexer 510 may retrieve information and store such information in a combined database 580 that includes information from the index database 560 and information from the social network database 540. Such a database may allow for expeditious searching and retrieval of information while a user is using a modeling application. Specifically, such an approach can enhance security and reduce time as Internet access is not necessarily required from the time a request is received from a user using a modeling application to the time a response is sent to the user. As to security, access to the Internet may occur at times where access to the combined database 580 is prohibited. Further, data scraped from a website of a social network may be cleansed, filtered, etc. to assure integrity and reduced risk of malicious code.

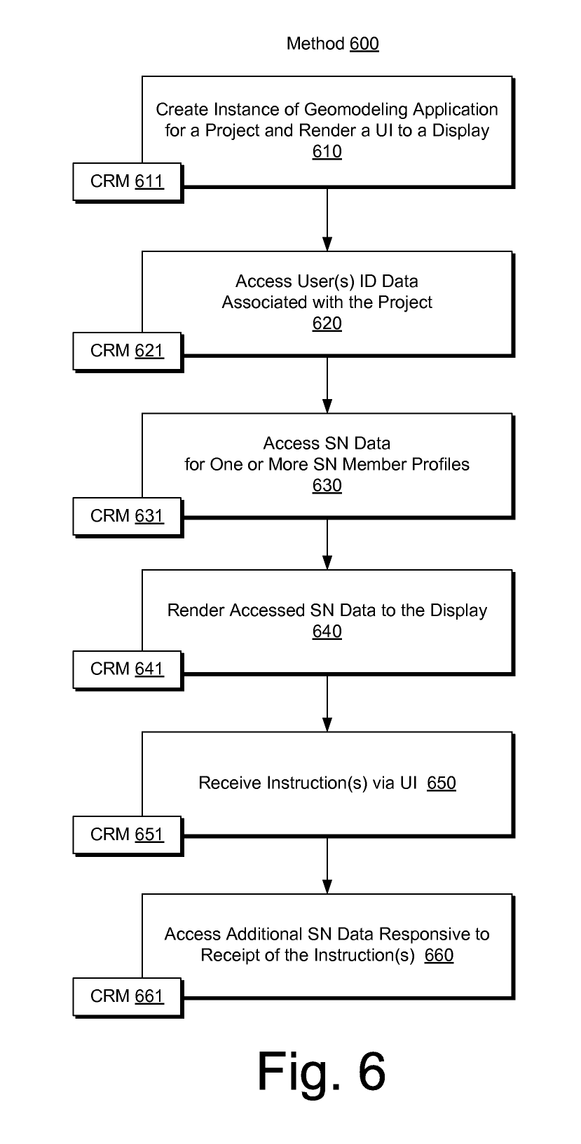

FIG. 6 shows an example of a method 600 that can integrate social network data into a user modeling experience. The method 600 includes a creation block 610 for creating an instance of a geomodeling application for a project and rendering an associated user interface to a display; an access block 620 for accessing user identity data associated with the project; an access block 630 for accessing social network data for one or more social network member profiles based on the user identity data; a render block 640 for rendering accessed social network data to the display; a reception block 650 for receiving an instruction via the user interface; and an access block 660 for accessing additional social network data responsive to receipt of the instruction.

In such a method, the access block 630 may provide for accessing a database that stores social network data associated with the user identity data, accessing the Internet to access social network data based on the user identity data or both. According to an embodiment, the access block 660 may provide for accessing a database that stores social network data associated with the user identity data, accessing a website for the social network via the Internet, or both.

According to an embodiment, a method can include accessing object property data associated with a project and accessing social network data for one or more social network member profiles based at least in part on the object property data. According to an embodiment, a method can include receiving one or more search criteria associated with a project and accessing social network data for one or more social network member profiles based at least in part on the one or more search criteria.

According to an embodiment, a method can include accessing social network data for one or more social network member profiles based on user identity data where the accessing social network data is based on a degree of relationship between members and a member associated with the user identity data. According to an embodiment, a method can include accessing social network data for one or more social network member profiles based on user identity data where the accessing social network data is based on organizational affiliation between members and a member associated with the user identity data.

The method 600 is shown in FIG. 6 in association with various computer-readable media (CRM) blocks 611, 621, 631, 641, 651, and 661. Such blocks generally include instructions suitable for execution by one or more processors (or cores) to instruct a computing device or system to perform one or more actions. While various blocks are shown, a single medium may be configured with instructions to allow for, at least in part, performance of various actions of the method 600.

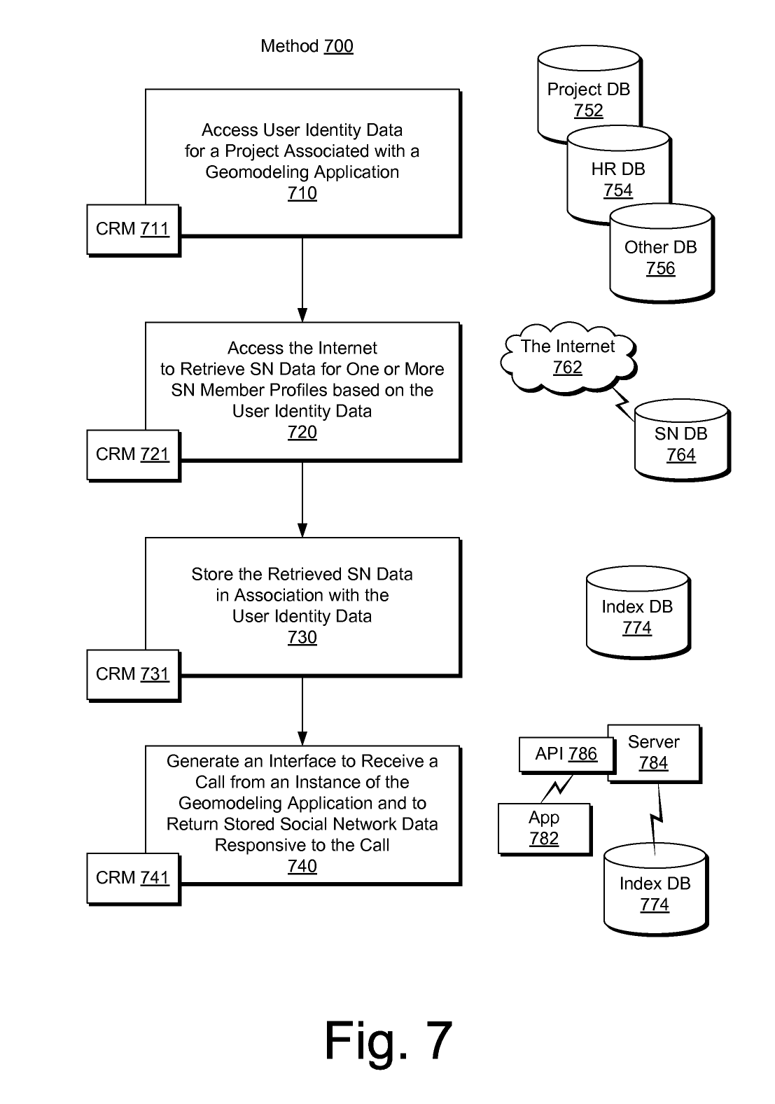

FIG. 7 shows an example of a method 700 that can store social network data in association with user identity data. Also shown in FIG. 7 are some examples of equipment, resources, etc., which may be part of a system within which the method 700 may perform.

As shown, the method 700 includes an access block 710 to access user identity data for a project associated with a geomodeling application; an access block 720 to access the Internet to retrieve social network data for one or more social network member profiles based on the user identity data; a storage block 730 to store the retrieved social network data in association with the user identity data; and a generation block 740 to generate an interface to receive a call from an instance of the geomodeling application and to return stored social network data responsive to the call.

As to the access block 710, it may access one or more databases such as a project database 752, a human resources database 754, or another database 756. As to the access block 720, it may access the Internet 762 and a social network database 764 in communication, directly or indirectly with the Internet 762. As to the storage block 730, it may store data in an index database 774. As to the generation block 740, it may generate an interface as an application programming interface (API) 786 where an application 782 can access a server 784 via the API 786 and, in turn, allow for exposure of data in the index database 774 (e.g., at least viewing of the data and optionally access and retrieval of the data).

The method 700 may optionally include a parse block to parse a call for user identity data and to access the stored, retrieved social network data based on the user identity data, to parse a call for user identity data and to access the Internet to retrieve social network data based on the user identity data, or both.

The method 700 may optionally include a generation block to generate an interface to receive a call from an instance of the geomodeling application and to access a social network website via the Internet responsive to the call.

According to an embodiment, a method may include a build block to build a group profile for a project based on project information and social network member profiles.

The method 700 is shown in FIG. 7 in association with various computer-readable media (CRM) blocks 711, 721, 731, and 741. Such blocks generally include instructions suitable for execution by one or more processors (or cores) to instruct a computing device or system to perform one or more actions. While various blocks are shown, a single medium may be configured with instructions to allow for, at least in part, performance of various actions of the method 700.

According to an embodiment, one or more computer-readable media can include computer-executable instructions to instruct a computer to: access user identity data for a project associated with a geomodeling application; access the Internet to retrieve social network data for one or more social network member profiles based on the user identity data; store the retrieved social network data in association with the user identity data; and generate an interface to receive a call from an instance of the geomodeling application and to return stored social network data responsive to the call. According to an embodiment, one or more computer-readable medium may include instructions to instruct a computer to parse a call for user identity data and to access the stored, retrieved social network data based on the user identity data; instructions to instruct a computer to parse a call for user identity data and to access the Internet to retrieve social network data based on the user identity data; instructions to instruct a computer to generate an interface to receive a call from an instance of the geomodeling application and to access a social network website via the Internet responsive to the call; instructions to instruct a computer to build a group profile for a project based on social network member profiles; or other instructions.

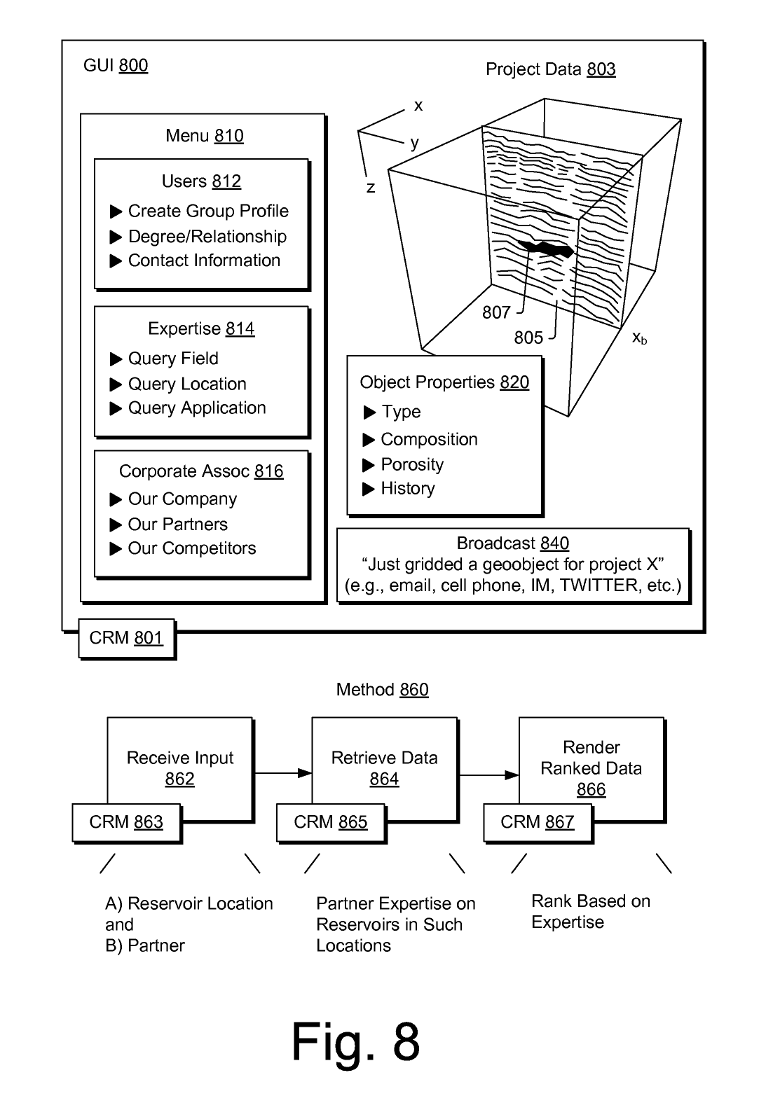

FIG. 8 shows an example of a graphical user interface (GUI) 800 and an example of a method 860, which may optionally perform based on input received via the GUI 800 (e.g., via a pointing device, touch screen, voice command, etc.).

As shown, the GUI 800 includes a graphical portion for rendering project data 803, which may be multi-dimensional data associated with a reservoir or, more generally, a subsurface formation. In the example of FIG. 8, the GUI 800 shows a 2D slice of the data 805 that includes a feature 807. Such a feature may be represented as an object by a modeling application and have associated object properties. In such an example, the GUI 800 may allow for user interaction to select the feature 807 and to display object properties 820 associated with the feature 807. For example, object properties 820 may include object type, composition, porosity, and history.

According to an embodiment, a GUI may include features for broadcasting information via a graphical broadcast control 840. Such a control may allow for broadcast via email, cell phone, text message, a social network such as the TWITTER® microblogging service (Twitter, San Francisco, Calif.) or other mode of communication. As an example, a user may type information during use of a modeling application. Additionally, or alternatively, a graphical user interface may include an option to automatically broadcast or to provide for “canned” predetermined broadcast messages. Accordingly, once a user performs a task, the GUI may access a message storage and broadcast a message associated with that task (e.g., optionally with amount of time taken to complete, success of completion, etc.). A manager may have a graphical interface that displays such microblogs by team members to thereby track progress on one or more modeling projects.

As to transmission of information via email, cell phone, text message, social network, etc., the GUI 800 may provide for scraping and parsing information associated with a social network website to identify contact information for an individual, organization, entity, etc. For example, a LINKEDIN® social network (LinkedIn Corp., Mountain View, Calif.) webpage for an individual may be accessed and its information (e.g., HTML) parsed for an email address, a phone number, an IM moniker, a TWITTER® microblog account, etc. In turn, a control may be rendered to a display that provides for selection of available contact options (e.g., allowing a user to select broadcast mode based on available options). As another example, consider a FACEBOOK® social network (Facebook, Palo Alto, Calif.) webpage that may be accessible for an organization (e.g., “North Sea Modeling Group XYZ”), where information may be transmitted from a modeling application via the Internet for posting to the “wall” for the organization. Thus, members of the organization can visit the social network webpage for updates or optionally receive email notifications from the social network responsive to such posts.

In the example of FIG. 8, the GUI 800 includes a menu 810 with various submenus: Users 812, Expertise 814 and Corporate Associations 816. According to an embodiment, such a menu structure can allow a user to input one or more instructions to carry out a process of social network data integration. According to an embodiment, selections made via a menu hierarchy may initiate a method such as the method 860.

In the example of FIG. 8, the method 860 includes a receipt block 862 for receiving input, a retrieval block 864 for retrieving data, and a render block 866 for rendering ranked data 866. In such an example, the reception block 862 may receive instructions via user selection of menu options displayed via the GUI 800 such as “reservoir location” from the expertise submenu 814 and “partner” from the corporate association submenu 816. In turn, the retrieval block 864 may retrieve member entries (e.g., member information) from a social network database (e.g., or an indexed database) that are for partners and with expertise at that particular location or one or more locations having similar characteristics. To facilitate user review of retrieved information, a ranking component may rank the results, for example, based on one or more criteria, which may differ from the input selections. In the example of FIG. 8, the ranking may be performed using an expertise formula that can account for various factors that indicate level of expertise (e.g., age, education, years at a location, application usage, etc.). Such a process may call for rendering of only some results, for example, a top five. In turn, the render block 866 can render ranked data, for example, a ranking of social network member profiles.

According to an embodiment, a method can include receiving input via a graphical user interface for a project associated with a geomodeling application; retrieving social network data for one or more social network member profiles responsive to receipt of the input; and rendering a ranking of member profiles. Where fee-based services (e.g., member consulting services) are available, fees for such services may be provided in a GUI (e.g., next to member name, etc.). Further, access restrictions may be presented for the various ranked member profiles (e.g., corporate partner, share-alike, limited to members of a professional organization, etc.).

As to scraping, such techniques may be implemented to access and transform structured or unstructured data (e.g., HTML or other format) into a particular structured form, for example, that can be rendered via a browser or other interface, stored, analyzed, etc. According to an embodiment, a modeling application, framework or indexer may include a bot component that scrapes data for further processing (e.g., parsing for contact information, expertise, location, etc.). Such a bot may conform to specifications for social network servers, which typically include a file (e.g., “robots.txt”) with rules for spidering or scraping of data accessible via such servers. As an example, consider the LINKEDIN® social network file at “http://www.linkedin.com/robots.txt”, which includes information as to user-agents and permissions (e.g., User-agent: Googlebot; Disallow: /addContacts*; Disallow:/addressBookExport*, etc.) as well as instructions for so-called “white listing”. A whitelist may be a list or register of entities that are being provided a particular privilege, service, mobility, access or recognition with respect to data or other functionality of a social network (see, e.g., the system 300 of FIG. 3). Accordingly, According to an embodiment, one or more of the components 405 or other components may rely on whitelisting, for example, an agreement to provide access to data, functionality, etc., or on a user-agent with suitable access.

The method 860 is shown in FIG. 8 in association with various computer-readable media (CRM) blocks 863, 865, and 867. Such blocks generally include instructions suitable for execution by one or more processors (or cores) to instruct a computing device or system to perform one or more actions. While various blocks are shown, a single medium may be configured with instructions to allow for, at least in part, performance of various actions of the method 860. The GUI 800 is shown in association with a CRM block 801, which may include instructions for rendering features of the GUI 800, which may be controls that can receive input via one or more manners (e.g., mouse, trackpad, touch screen, keyboard, voice command, etc.).

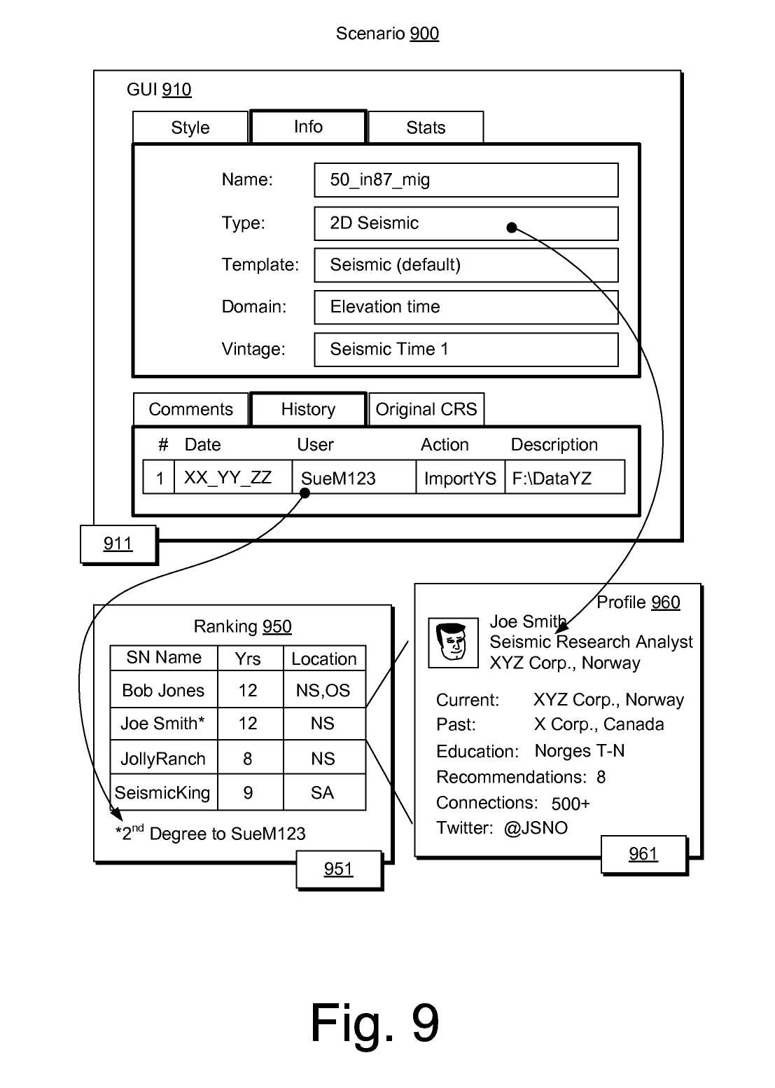

FIG. 9 shows an example of a scenario 900 that includes a graphical user interface 910, a ranking graphic 950 and a profile graphic 960, which may be a profile as available via a website of a social network.

In the example of FIG. 9, the GUI 910 may be a GUI associated with a geomodeling application such as the PETREL® application hosted by the OCEAN® framework. The GUI 910 shows various information associated with a project, and such information may be specific to an object in the project. As shown, the type is “seismic”, which may be information relied on to pull helpful social network data. Further, the GUI 910 shows a history with a user identifier “SueM123”, which may be unique to a corporation. This user identifier may include, for example, an email address, a human resources database identifier, etc. Accordingly, the actual identity of SueM123 may be known by accessing information within an organization and such information may be used to pull, filter or pull and filter social network data.

As mentioned, during modeling, a user may wish to access knowledge or data to facilitate or increase accuracy of her modeling effort. By inputting a command (e.g., click, voice, keyboard, etc.), a modeling application used by the user may initiate a process that accesses social network data and provides a ranking of members (e.g., typically individuals) via a ranking graphic such as the ranking graphic 950. As shown, in the scenario 900, the user may then select one of the ranked members to cause rendering of a corresponding profile (via profile graphic 960) for that member.

In the particular example of FIG. 9, the user SueM123 in the history graphic of the GUI 910 may be the current user or a past user. As such information is available (e.g., index information), it may be used in a ranking analysis or may cause rendering of information that demonstrates a link between a member and the user SueM123. For example, if the social network member Joe Smith has a 2^{nd} degree relationship to the user SueM123, that information may be rendered to a display via a ranking or other graphic.

As to the profile graphic 960, it may include keywords associated with information in the GUI 910 or otherwise associated with the project or object for which the GUI 910 corresponds. As an example, the type field of the GUI 910 includes the word “seismic”, which may be a keyword for an expertise or other search that accesses information for social network members with “seismic” in their title (or another field of a member profile).

The GUIs 910, 950 and 960 are shown in FIG. 8 in association with various computer-readable media (CRM) blocks 911, 951, and 961. Such blocks generally include instructions suitable for execution by one or more processors (or cores) to instruct a computing device or system to perform one or more actions and to render graphics. While various blocks are shown, a single medium may be configured with instructions to allow for, at least in part, performance of various actions such as rendering graphics 910, 950 or 960.

According to an embodiment, one or more computer-readable media may include computer-executable instructions to instruct a computing system to output information for controlling a process. For example, such instructions may provide for output to sensing process, an injection process, drilling process, an extraction process, etc.

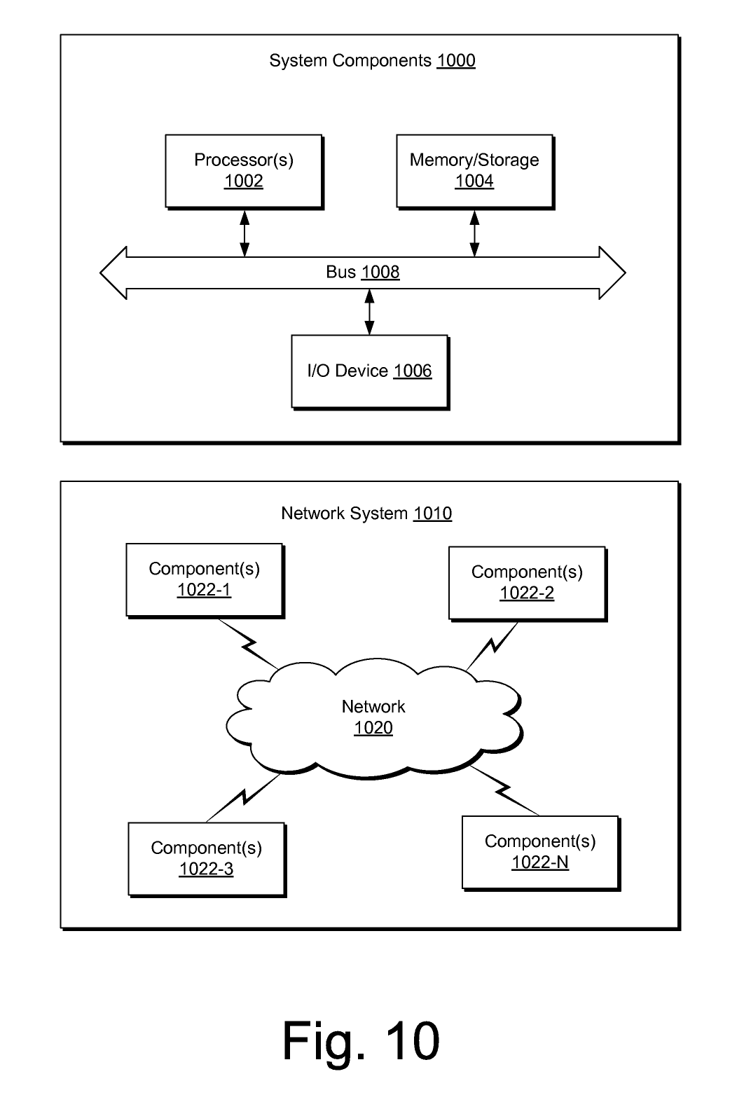

FIG. 10 shows components of a computing system 1000 and a networked system 1010. The system 1000 includes one or more processors 1002, memory and/or storage components 1004, one or more input and/or output devices 1006 and a bus 1008. According to an embodiment, instructions may be stored in one or more computer-readable media (e.g., memory/storage components 1004). Such instructions may be read by one or more processors (e.g., the processor(s) 1002) via a communication bus (e.g., the bus 1008), which may be wired or wireless. The one or more processors may execute such instructions to implement (wholly or in part) one or more attributes (e.g., as part of a method). A user may view output from and interact with a process via an I/O device (e.g., the device 1006). According to an embodiment, a computer-readable medium may be a storage component such as a physical memory storage device, for example, a chip, a chip on a package, a memory card, etc.

According to an embodiment, components may be distributed, such as in the network system 1010. The network system 1010 includes components 1022-1, 1022-2, 1022-3, . . . 1022-N. For example, the components 1022-1 may include the processor(s) 1002 while the component(s) 1022-3 may include memory accessible by the processor(s) 1002. Further, the component(s) 1002-2 may include an I/O device for display and optionally interaction with a method. The network may be or include the Internet, an intranet, a cellular network, a satellite network, etc.

### CONCLUSION

Although various methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

1. A method comprising:
creating an instance of a geomodeling application for a project and rendering an associated user interface to a display;
accessing user identity data associated with the project;
accessing social network data for one or more social network member profiles based on the user identity data;
rendering accessed social network data to the display;
receiving an instruction via the user interface; and
accessing additional social network data responsive to receipt of the instruction.

2. The method of claim 1 wherein the accessing social network data comprises accessing a database that comprises social network data associated with the user identity data.

3. The method of claim 1 wherein the accessing social network data comprises accessing the Internet to access social network data based on the user identity data.

4. The method of claim 1 wherein the accessing additional social network data responsive to receipt of the instruction comprises accessing a database that comprises social network data associated with the user identity data.

5. The method of claim 1 wherein the accessing additional social network data responsive to receipt of the instruction comprises accessing a website for the social network via the Internet.

6. The method of claim 1 further comprising accessing object property data associated with the project; and accessing social network data for one or more social network member profiles based at least in part on the object property data.

7. The method of claim 1 further comprising receiving one or more search criteria associated with the project; and accessing social network data for one or more social network member profiles based at least in part on the one or more search criteria.

8. The method of claim 1 wherein the accessing social network data for one or more social network member profiles based on the user identity data comprises accessing social network data based on a degree of relationship between members and a member associated with the user identity data.

9. The method of claim 1 wherein the accessing social network data for one or more social network member profiles based on the user identity data comprises accessing social network data based on organizational affiliation between members and a member associated with the user identity data.

10. One or more computer-readable media comprising computer-executable instructions to instruct a computer to:
access user identity data for a project associated with a geomodeling application;
access the Internet to retrieve social network data for one or more social network member profiles based on the user identity data;
store the retrieved social network data in association with the user identity data; and
generate an interface to receive a call from an instance of the geomodeling application and to return stored social network data responsive to the call.

11. The one or more computer-readable media of claim 10 comprising computer-executable instructions to instruct a computer to parse a call for user identity data and to access the stored, retrieved social network data based on the user identity data.

12. The one or more computer-readable media of claim 10 comprising computer-executable instructions to instruct a computer to parse a call for user identity data and to access the Internet to retrieve social network data based on the user identity data.

13. The one or more computer-readable media of claim 10 comprising computer-executable instructions to instruct a computer to generate an interface to receive a call from an instance of the geomodeling application and to access a social network website via the Internet responsive to the call.

14. The one or more computer-readable media of claim 10 comprising computer-executable instructions to instruct a computer to build a group profile for a project based on social network member profiles.

15. The one or more computer-readable media of claim 10 comprising computer-executable instructions to instruct a computer to, responsive to a call, return a member ranking that ranks members of the social network based on information communicated by the call.

16. One or more computer-readable media comprising computer-executable instructions to instruct a computer to:
receive input via a graphical user interface for a project associated with a geomodeling application;
retrieve social network data for one or more social network member profiles responsive to receipt of the input; and
render a ranking of member profiles.

17. The one or more computer-readable media of claim 16 comprising computer-executable instructions to instruct a computer to access a member profile responsive to receipt of an instruction that selects one of the member profiles of the ranking.

18. The one or more computer-readable media of claim 16 further comprising computer-executable instructions to instruct a computer to broadcast a message to a microblog.

19. The one or more computer-readable media of claim 16 comprising computer-executable instructions to instruct a computer to render a graphical menu that lists search options as inputs.

20. The one or more computer-readable media of claim 16 comprising computer-executable instructions to instruct a computer to provide an object property as an input.
